(19) United States
(12) Patent Application Publication
(10) Pub. No.: US 2005/0086537 A1
(43) Pub. Date: Apr. 21, 2005

(54) Methods and system for replicating and securing process control data

(76) Inventor: Alex Johnson, Houston, TX (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/967,512

(22) Filed: Oct. 18, 2004

Related U.S. Application Data
(60) Provisional application No. 60/512,503, filed on Oct. 17, 2003.
(60) Provisional application No. 60/549,342, filed on Mar. 1, 2004.
(60) Provisional application No. 60/588,622, filed on Jul. 16, 2004.

(51) Int. Cl. H04L 9/00

(52) U.S. Cl. 713/201

(57) ABSTRACT

Methods and systems are provided to replicate and secure process control system data. Devices coupled to a process control network produce data that is collected by a host on the network. This data may be provided to users of computers that are not on the process control network, without increasing the network's vulnerability to network attacks. To achieve this security, an isolation system including a firewall and an application workstation are placed between the host and the non-network computers. The host pushes the data through the firewall to the application workstation, which includes the same application program interface found on the host. Thus, non-network computers can not identify that the data provided to them is coming from the application workstation instead of the process control network. The firewall is configured to prevent most or all outside communications with the network. Thus, the network is protected from attacks while providing its data to non-network computers.

### CROSS-REFERENCE TO RELATED APPLICATIONS

The present application claims the benefit of the following U.S. Provisional Patent Applications: Ser. No. 60/512,503, which was filed on Oct. 17, 2003, by Alex Johnson for “Methods and System for Replicating and Securing Process Control Data;” Ser. No. 60/549,342, which was filed on Mar. 1, 2004, by Bharat Khuti, Clayton Coleman, David Rath, Ernest Rahaczky, Jim Leslie, Juan Peralta, and George Simpson for “Process Control Methods and Apparatus for Intrusion Protection and Network Hardening;” and Ser. No. 60/588,622, which was filed on Jul. 16, 2004, by Bharat Khuti, Clayton Coleman, David Rath, Ernest Rahaczky, Jim Leslie, Juan Peralta, and George Simpson for “Process Control Methods and Apparatus for Intrusion Protection and Network Hardening,” all of which are hereby incorporated by reference.

### BACKGROUND OF THE INVENTION

1. Field of the Invention

The disclosed methods and systems relate generally to process control systems, and more particularly to load balancing and protection of process control system data and devices.

2. Background Information

A process control system may be constructed from equipment generally known as distributed control system (DCS) equipment, programmable logic controller (PLC) equipment and/or Supervisory Control and Acquisition Data (SCADA) equipment. Generally, DCS equipment may integrate data from other sources and provide a primary Human-Machine Interface (HMI) and a platform for various other applications, e.g., historians, multi-variable controllers, change tracking software, etc. The I/A SERIES system from Invensys Systems, Inc. is one such DCS, but other such systems are known in the art. Generally, DCS systems use general purpose computers, such as PCs and workstations, to implement their HMI, control, and general computing facilities. Since these computers are generally connected to plant computer networks as well as the DCS, and since these computers generally use commercial operating systems, e.g., Sun's Solaris, HP's HP-UX, and Microsoft's Windows, they may be subject to network attacks, i.e., operational compromise by viruses, worms, and Trojan horses, among other types of attacks.

### SUMMARY OF THE INVENTION

In an illustrative embodiment, there is provided a method for replicating and securing process control system data on a process control network. The method includes collecting, at a host, process control system data from at least one network device. The host then exposes a data access application program interface. At least a subset of the process control system data is then pushed from the host to the isolation system via a first firewall. In an alternate embodiment, all ports of the first firewall may be closed to any network traffic initiated from outside of the first firewall. In another alternate embodiment, at least one selected port of the first firewall may be open to network traffic initiated from a specific network address that is outside of the first firewall. Finally, the isolation system exposes the data access application program interface, which is the same data access application program interface as that exposed by the host.

In another embodiment, the method may also include hosting applications on the isolation system. Further, the applications may be specific to the process control network. In yet another embodiment, the method may also include indicating if the collected process control system data is read-only of if it may be modified.

In still another embodiment, the method may also include providing access to the process control system data at the isolation system to at least one non-network computer operatively coupled to the isolation system. In addition, this access may be provided via the data access application program interface. Further, the method may also include hosting applications on the isolation system that are provided from the at least one non-network computer.

In a related embodiment, the method may also include protecting the isolation system with a second firewall placed between the isolation system and the at least one non-network computer. Further, at least one selected port of the second firewall may be open to network traffic initiated from a specific network address that is outside of the second firewall.

In yet another related embodiment, collecting process control system data may involve a first protocol, such as an object manager data transfer protocol. Further, providing access to at least one non-network computer may involve a second protocol, such as an X-Windows protocol. In addition, pushing at least a subset of the data from the host to the isolation system may involve a third protocol, such as an application programming interface protocol.

In another illustrative embodiment, there is provided a secure process control system, which includes a process control network. The process control network includes at least one network device with process control system data. The secure process control system also includes a host and an isolation system. The host includes a data collector and a data pusher. The data collector is capable of collecting process control system data and exposing a data access application program interface. The isolation system is capable of receiving collected data pushed from the data pusher. The isolation system includes an application workstation and a first firewall between the host and the application workstation. The application workstation is capable of exposing the data access application program interface, which is the same data access application program interface as that of the host. In an alternate embodiment, all ports of the first firewall may be closed to any network traffic initiated from outside of the first firewall. In another alternate embodiment, at least one selected port of the first firewall may be open to network traffic initiated from a specific network address that is outside of the first firewall.

In a further embodiment, the isolation system may further be capable of hosting applications. Further, the applications may be specific to the process control network. In yet another further embodiment, the isolation system may also include an indicator, activated by the host, that identifies the process control system data as read-only or as read-write.

In another further embodiment, the secure process control system may also include at least one non-network computer, operatively coupled to the isolation system. Further, the isolation system may further be capable of hosting applications provided from the at least one non-network computer.

In a related embodiment, the secure process control system may also include a second firewall, placed between the isolation system and the at least one non-network computer. In addition, at least one selected port of the second firewall may be open to network traffic initiated from a specific network address that is outside of the second firewall.

In another related embodiment, the secure process control system may also include a first protocol, such as a standard object manager data transfer protocol, used for communications between the at least one network device and the host; a second protocol, such as X-Windows, used for communications between the isolation system and the at least one non-network computer; and a third protocol, such as an application programming interface protocol, used for communications between the host and the isolation system.

In yet another illustrative embodiment, there is provided a computer program product for replicating and securing process control system data on a process control network. The computer program product comprises: computer program code for collecting, at a host, process control system data from at least one network device from at least one network device; computer program code for exposing, from the host, a data access application program interface; computer program code for pushing at least a subset of the collected data from the host to an isolation system via a first firewall; and computer program code for exposing, from the isolation system, the data access application program interface, wherein the data access application program interface is the same at both the host and the isolation system. In an alternate embodiment, all ports of the first firewall may be closed to any network traffic initiated from outside of the first firewall. In another alternate embodiment, at least one selected port of the first firewall may be open to network traffic initiated from a network address that is outside of the first firewall.

In another embodiment, the computer program product may include computer program code for hosting applications on the isolation system. Additionally, the applications may be specific to the process control network. In yet another embodiment, the computer program product may include computer program code for indicating if at least one subset of the process control system data is read-only or if at least one subset of the process control system data may be modified.

In yet another embodiment, the computer program product may also include computer program code for providing access to the process control system data at the isolation system to at least one non-network computer operatively coupled to the isolation system. In addition, this access may be provided via the data access application program interface. Further, the computer program product may also include computer program code for hosting applications on the isolation system that are provided from the at least one non-network computer.

In a related embodiment, the computer program product may include computer program code for protecting the isolation system with a second firewall placed between the isolation system and the at least one non-network computer. Additionally, at least one selected port of the second firewall may be open to network traffic initiated from a specific network address that is outside of the second firewall.

In yet another related embodiment, the computer program code for collecting process control system data may involve a first protocol, such as an object manager data transfer protocol. Further, the computer program code for providing access to at least one non-network computer may involve a second protocol, such as X-Windows. Further, the computer program code for pushing at least a subset of the collected data from the host to the isolation system may involve a third protocol, such as an application programming interface protocol.

### BRIEF DESCRIPTION OF THE DRAWINGS

The invention description below refers to the accompanying drawings, of which:

FIG. 1 shows a process control system accessed by outside users according to the prior art.

FIG. 2 shows a process control system accessed by outside users secured by an isolation station and firewalls.

### DETAILED DESCRIPTION OF AN ILLUSTRATIVE EMBODIMENT

To provide an overall understanding, certain illustrative embodiments will now be described; however, it will be understood by one of ordinary skill in the art that the systems and methods described herein may be adapted and modified to provide systems and methods for other suitable applications and that other additions and modifications may be made without departing from the scope of the systems and methods described herein.

Unless otherwise specified, the illustrated embodiments may be understood as providing exemplary features of varying detail of certain embodiments, and therefore, unless otherwise specified, features, components, modules, and/or aspects of the illustrations may be otherwise combined, separated, interchanged, and/or rearranged without departing from the disclosed systems or methods. Additionally, the shapes and sizes of components are also exemplary and unless otherwise specified, may be altered without affecting the scope of the disclosed and exemplary systems or methods of the present disclosure.

Although the disclosed methods and systems may, at times, be described relative to a specific proprietary system, it is understood that the disclosed methods and systems may include other process control systems and/or distributed control systems that may employ, for example, PLCs, SCADA systems, and other sources of process data and control. Further, although the disclosed methods and systems may refer accordingly to first, second, and third protocols that may be proprietary and/or otherwise associated with a given network, the disclosed methods and systems are not limited to the use of the specified protocols and/or methods of data exchange and/or communications.

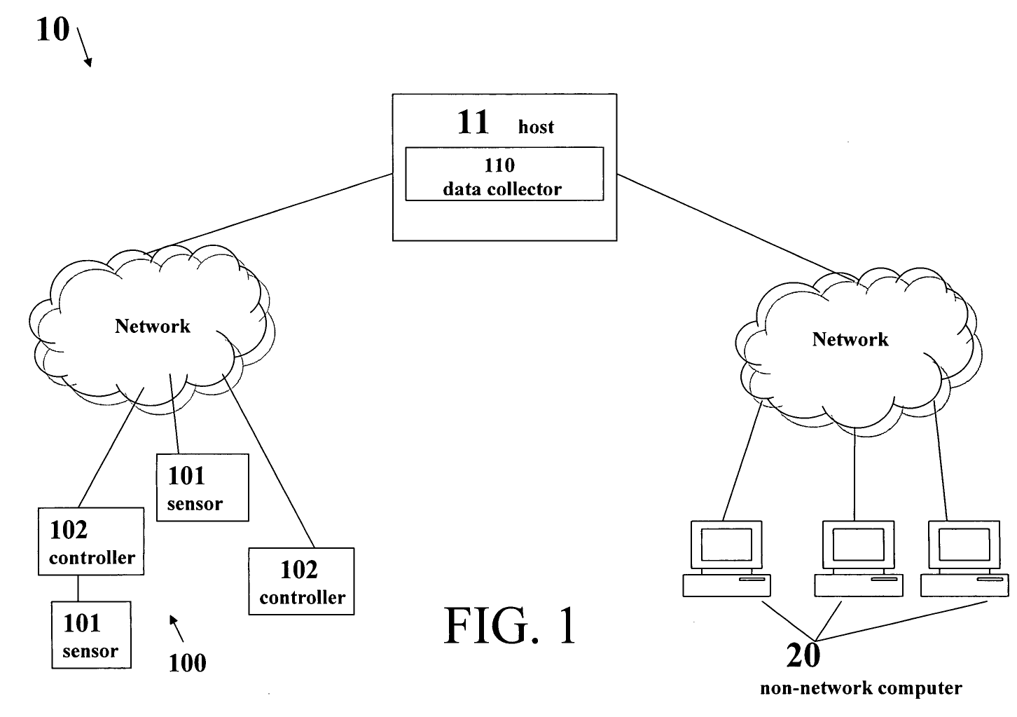

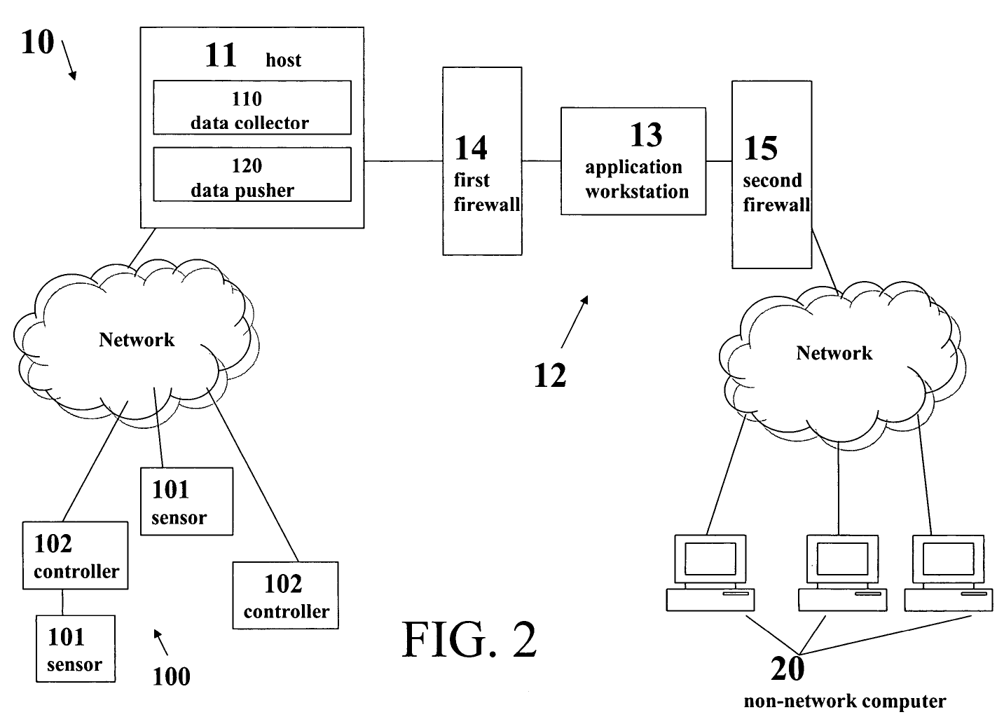

It should be noted that the connections shown in both FIG. 1 and FIG. 2 may be implemented through cables connecting with Network Interface Cards (NICs) and/or some other Ethernet port or Ethernet ports, for example. However, it is understood that network connections are not limited to such cable connections; various other wired and/or wireless network connections may be made between the devices shown in both FIG. 1 and FIG. 2, and the disclosed methods and systems may include such combinations.

FIG. 1 shows an illustrative embodiment of a process control system according to the prior art. At least one non-network computer 20 is able to interface to a process control network 10 through a host 11, to acquire or send process control system data to the process control network 10. Process control system data includes any data generated by any network device connected to a process control network 10, such as network devices 100, or any data generated to be used as an input to such a device. The process control network 10 includes a host 11 and various network devices 100, such as sensors 101 and controllers 102.

The host 11 is a computer, or other microprocessor-controlled device with memory and an input device that is capable of being connected to a network. The host 11 includes a data collector 110, which collects process control system data from the network devices 100. The data is typically in the format of object manager variables, though of course any data format may be used. Each object manager variable has a unique identifier associated with it, known as a tag. To make the data available to a non-network computer 20, the host 11 exposes a data access application program interface (“data access API”). The non-network computer 20 is then able to take the process control system data from the host 11, and perform operations on the data, by invoking, for example, API routines. Thus, the non-network computer 20 should not able to tell that the data it is using is coming from the host 11 via the data access API instead of, for example, coming from the network devices 100 on the process control network 10.

However, by providing access to the host 11 from non-network computers 20, the host 11 and thus the entire process control network 10 may become vulnerable to network attacks, such as a denial-of-service attack, access by unauthorized users, viruses, worms, Trojan-horse code, and so on. The vulnerability further depends, to a degree, on the operation system used by the host 11, and the protocols used for communications between the host 11 and the non-network computers 20. Even if a firewall (not shown in FIG. 1) is placed between the host 11 and the non-network computers 20, because the non-network computers 20 must communicate with the host 11 in order to access the control process system data, the host 11 and the process control network 10 may still be vulnerable to attack. Further, because the host 11 performs other tasks for the process control network 10 in addition to serving as the interface for communications with non-network computers 20, these other tasks may also be affected if an attack occurs.

FIG. 2 shows an illustrative embodiment of the current invention, where an isolation system 12 is placed between the process control network 10 and the non-network computers 20. The isolation system 12 effectively protects the process control network 10 from the types of attacks described above, while still providing process control system data to non-network computers 20. As will be explained below, the isolation system 12 provides this protection by introducing controlled isolation to the process control network 10. Further, because the isolation system 12 may serve as the platform on which software applications may run, load control issues that affected the host 11 are removed from affecting either the host 11 or the process control network 10. It should be noted that the isolation system 12 itself may be vulnerable to attacks and/or load control issues.

The isolation system 12 includes an application workstation 13 and a first firewall 14. For example, the application workstation 13 may be, but is not limited to, a computer and/or other microprocessor-controlled device with memory and an input device that may be connected to a network. Further, the application workstation 13 may be the same as any computer or other microprocessor-controlled device operatively coupled to the process control network 10, such as the host 11, that additionally includes the functionality described below and is also located as part of the isolation system 12. The first firewall 14 includes various security measures, for example but not limited to password protection. The first firewall 14 may be hosted on the application workstation 13 or may be a separate network entity. In an illustrative embodiment, the first firewall 14 is located between the application workstation 13 and the host 11. In this configuration, the host 11 acts as an interface between the process control network 10 and the isolation system 12. Further, to employ greater security and offer further protection to the process control network 10 and its data, an optional second firewall 15 may be employed between the isolation system 12 and the non-network computers 20 as shown in FIG. 2. Additionally, the operating system of the application workstation 13 and/or the protocol used for communications between the host 11 and the application workstation 13 may be chosen to provide further decreased vulnerability to attacks.

Various protocols may be used for communications between the devices shown in FIG. 2. For example, the network devices 100 may interface with the host 11 by use of a first protocol. This first protocol may be, but is not limited to, a network-specific transfer scheme/protocol, such as a data transfer object manager protocol. The isolation system 12 may communicate with the non-network computers 20 by using a second protocol, which may include but is not limited to the X-Windows protocol. The host 11 may employ a third protocol, such as but not limited an application programming interface protocol, an example of which is Invensys Systems Inc.'s netFox API, to communicate with the isolation system 12. The use of different protocols for communications between different elements allows the system to choose protocols that may handle the specific requirements of the communications.

For a non-network computer 20 to access process control system data, the data must be collected from the at least one network device 100 and then placed on the isolation system 12. More specifically, the data collector 110 of the host 11 collects the data as described in connection with FIG. 1. To allow computers, or other microprocessor-controlled devices (both not shown in FIG. 2), operatively coupled to the process control network 10 to access the data, the host 11 exposes a data access API. Once at least a subset of the process control system data is collected, the data pusher 120 will push this data from the host 11, through the first firewall 14, to the application workstation 13 of the isolation system 12.

Depending on the level of security desired, the first firewall 14 may be configured to allow varying types of access to the process control network 10 and/or any device attached to or part of the process control network 10. The types of access may include, but are not limited to, secure access, authenticated access, limited access, and/or privileged access. The most-restrictive access is achieved by configuring the first firewall 14 to be closed to all traffic initiated from outside of the first firewall 14. Thus, all ports of the first firewall 14 for communications from the non-process control network side of the firewall are closed. (Used in this context, a port is the endpoint of a logical connection, typically identified by a port number, such as but not limited to the port numbers assigned by the Internet Assigned Numbers Authority, or identified by another value obtained from the de-multiplexing field of a communications protocol.) This closes access not only from non-network computers 20 but also from the application workstation 13. Thus, the process control system data located at the application workstation 13 are treated as being read-only; i.e., non-network computers 20 may read this data, but any changes made to the data at the application workstation 13 or at the non-network computers 20 will not be communicated to the process control network 10. This protects the process control network 10 from attacks such as a denial-of-service attack. It should be noted that, in this configuration, even if the application workstation 13 is compromised, the process control network 10 is not compromised, because the first firewall 14 blocks all traffic generated by the application workstation 13.

Less-restrictive access may be achieved by configuring the first firewall 14 differently. By opening a single selected port of the first firewall 14, for example but not limited to the port corresponding to the third protocol, to communications from a particular network address, for example but not limited to the network address of the application workstation 13, limited two-way communication is provided. Thus, only specified users are allowed to communicate with the process control network 10, or only in specified manners. This configuration limits potential attack points to protocols that are deemed reliable by the process control network 10. Additionally, if different protocols with different capabilities are required between the isolation system 12 and the process control network 10, the corresponding ports may be opened on the first firewall 14. Of course, this will result in an associated increase in risk to the process control network 10. However, it should be noted that the first firewall 14 minimizes the chance that a virus/worm/Trojan horse/other malicious code will spread. This is because the port number used by the protocol(s) and the protocol(s) themselves are not widely known and thus are unlikely to be targets of malicious code and/or other intrusive software, and further because the servers supporting the protocol(s) would reject improper messages. Of course, the second firewall 15 may also be configured, for example but not limited to, the same configurations as the first firewall 14, to provide additional layers of security to the isolation system 12. Using both the first firewall 14 and the second firewall 15 ensures that only the isolation system 12 has access to the process control network 10 and that only authorized non-network computers 20 have access to the isolation system 12.

With the process control system data transferred to the isolation system 12, the isolation system 12, particularly the application workstation 13, must now make the process control system data available to the non-network computers 20. Further, to achieve the functionality available to the non-network computers 20 in the prior art, the application workstation 13 should appear, to the non-network computers 20, as the host 11 appeared in the prior art; i.e., the application workstation 13 should appear to them to provide the same functionality as the host 11. The application workstation 13 achieves this by exposing, to the non-network computers 20, the same data access API exposed by the host 11 to computers or other devices operatively coupled to the process control network 10. The application workstation 13 uses the second protocol to expose the data access API to the non-network computers 20, and uses the second protocol for all further communications with the non-network computers 20. Because the application workstation 13 has same process control system data as found on the process control network 10, and exposes the same data access API as the host 11, the non-network computers 20 thus may deal with the isolation system 12 as they would have with the process control network 10.

For the non-network computers 20 to make use of the data, the application workstation 13 may host one or more applications, such as but not limited to third party software tools or software tools particular to the process control network 10. These applications may be used by non-network computers 20 to perform various operations on the data. Because the applications execute on the isolation system 12, and not on the process control network 10, and since the isolation system can be configured such that request load from the process control network 10 is not excessive, the isolation system 12 may thus be employed to resolve load-control issues. Further, software at the isolation system 12, such as Human-Machine Interface (HMI) software, may be configured to provide additional security, such as identifying only specific non-network computers 20 for access to the isolation system 12 or limiting access by a specific non-network computer to only certain data.

If the isolation system 12 is configured to allow non-network computers 20 to have access to the process control network 10, the non-network computers 20 may communicate data to the process control network 10. These data may be new data generated by the non-network computers 20, or otherwise provided to them, or they may be a modified version of the process control system data from the data access API. The non-network computers may designate their data as, for example, read-only or read-write. The process control network 10 may also designate certain data as read-only instead of as read-write, limiting the changes non-network computers 20 may make. Whether the data are to be designated as read-only or read-write depends upon a configuration file located at the host 11. This status is indicated to the application workstation 13. If the data are designated as read-write, then non-network computers 20 may make changes to the data on a tag-by-tag basis, using the tag of a subset of the data to indicate which subset should be changed. To send any data, including modified data, to the process control network 10, the non-network computers 20 must first go through the isolation system 12 and the host 11. Thus, it should be noted that the non-network computers 20 do not have direct control over the process control network 10 itself. When the data are sent from the non-network computers 20 via the isolation system 12 and the host 11 to the process control network 10, the isolation system 12 software provides read-back of the changed values to the non-network computers 20 to ensure that the changes are also reflected locally. This functionality facilitates alarm acknowledgements and set-point ramping. Software on the isolation system 12 is also capable of receiving messages sent to the isolation system 12, and if desired to the non-network computers 20, from the process control network 10, including, for example but not limited to, alarm messages. A configuration file in the isolation system 12 specifies target alarm annunciation devices on the isolation system 12. The configuration file identifies various types of events that may occur on the process control network 10, and the type of alarm may depend on the event. For example, if the event is a simple error on a network device, the configuration file may associate it with a small pop-up window or low-tone beep on the isolation system 12. As a further example, if the event is the imminent shutdown of multiple network devices, the configuration file may associate it with a loud noise and other appropriate indicators at the isolation system 12. For the isolation system 12 to acknowledge to the process control network 10 that a message has been received requires the isolation system 12 to be configured to communicate with the process control network 10. Further, write access by the isolation system 12 may also be required.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

1. A method of replicating and securing process control system data on a process control network, comprising:
collecting, at a host, process control system data from at least one network device;
exposing, from the host, a data access application program interface;
pushing at least a subset of the collected process control system data from the host to an isolation system via a first firewall; and
exposing, from the isolation system, the data access application program interface, wherein the data access application program interface is the same at both the host and the isolation system.

2. The method according to claim 1, further comprising:
providing access to the process control system data on the isolation system to at least one non-network computer operatively coupled to the isolation system.

3. The method according to claim 2, wherein providing access includes providing access, to the process control system data on the isolation system, via the data access application program interface.

4. The method according to claim 1, further comprising:
hosting applications on the isolation system.

5. The method according to claim 4, wherein hosting comprises hosting applications, on the isolation system, specific to the process control network.

6. The method according to claim 2, further comprising hosting applications, on the isolation system, provided from the at least one non-network computer.

7. The method according to claim 1, wherein pushing comprises pushing at least a subset of the collected process control system data from the host to the isolation system via a first firewall, where at least one selected port of the first firewall is open to network traffic initiated from a specific network address that is outside of the first firewall.

8. The method according to claim 1, wherein pushing comprises pushing at least a subset of the collected process control system data from the host to an isolation system via a first firewall, where all ports of the first firewall are closed to any network traffic initiated from outside of the first firewall.

9. The method according to claim 2, further comprising:
protecting the isolation system with a second firewall placed between the isolation system and the at least one non-network computer.

10. The method according to claim 9, wherein protecting comprises protecting the isolation system with a second firewall placed between the isolation system and the at least one non-network computer, where at least one selected port of the second firewall is open to network traffic initiated from a specific network address that is outside of the second firewall.

11. The method according to claim 1, further comprising:
indicating if the collected process control system data is read-only or if the collected process control system data may be modified.

12. The method according to claim 2, wherein collecting involves a first protocol, providing involves a second protocol, and pushing involves a third protocol.

13. The method according to claim 12, wherein collecting involves an object manager data transfer protocol, providing involves an X-Windows protocol, and pushing involves an application programming interface protocol.

14. A secure process control system, including a process control network, where the process control network includes at least one network device with process control system data, the secure process control system comprising:
a host, comprising:
a data collector, wherein the data collector is capable of collecting process control system data and exposing a data access application program interface; and
a data pusher;
and
an isolation system, capable of receiving collected process control system data pushed from the data pusher, wherein the isolation system comprises:
an application workstation, capable of exposing the data access application program interface, wherein the data access application program interface is the same at both the host and the isolation system; and
a first firewall between the host and the application workstation.

15. The secure process control system according to claim 14, further comprising:
at least one non-network computer, operatively coupled to the isolation system.

16. The secure process control system according to claim 14, wherein the isolation system is further capable of hosting applications.

17. The secure process control system according to claim 16, wherein the isolation system is further capable of hosting applications specific to the process control network.

18. The secure process control system according to claim 15, wherein the isolation system is further capable of hosting applications provided from the at least one non-network computer.

19. The secure process control system according to claim 14, wherein at least one selected port of the first firewall is open to network traffic initiated from a specific network address that is outside of the first firewall.

20. The secure process control system according to claim 14, wherein all ports of the first firewall are closed to any network traffic initiated from outside of the first firewall

21. The secure process control system according to claim 15, further comprising:
a second firewall, placed between the isolation system and the at least one non-network computer.

22. The secure process control system according to claim 21, wherein at least one selected port of the second firewall is open to network traffic initiated from a specific network address that is outside of the second firewall.

23. The secure process control system according to claim 15, wherein the isolation system further comprises an indicator, activated by the host, that identifies the process control system data as read-only or as read-write.

24. The secure process control system according to claim 15, further comprising:
a first protocol, used for communications between the at least one network device and the host;
a second protocol, used for communications between the isolation system and the at least one non-network computer; and
a third protocol, used for communications between the host and the isolation system.

25. The secure process control system according to claim 24, wherein the first protocol comprises an object manager data transfer protocol; wherein the second protocol comprises an X-Windows protocol; and wherein the third protocol comprises a application programming interface protocol.

26. A computer program product for replicating and securing process control system data on a process control network, comprising:
computer program code for collecting, at a host, process control system data from at least one network device;
computer program code for exposing, from the host, a data access application program interface;
computer program code for pushing at least a subset of the collected process control system data from the host to an isolation system via a first firewall; and
computer program code for exposing, from the isolation system, the data access application program interface, wherein the data access application program interface is the same at both the host and the isolation system.

27. The computer program product according to claim 26, further comprising:
computer program code for providing access to the process control system data on the isolation system to at least one non-network computer operatively coupled to the isolation system.

28. The computer program product according to claim 27, wherein computer program code for providing access includes computer program code for providing access, to the process control system data on the isolation system, via the data access application program interface.

29. The computer program product according to claim 26, further comprising:
computer program code for hosting applications on the isolation system.

30. The computer program product according to claim 29, wherein computer program code for hosting comprises computer program code for hosting applications, on the isolation system, specific to the process control network.

31. The computer program product according to claim 27, further comprising computer program code for hosting applications, on the isolation system, provided from the at least one non-network computer.

32. The computer program product according to claim 26, wherein computer program code for pushing comprises computer program code for pushing at least a subset of the collected process control system data from the host to the isolation system via a first firewall, where at least one selected port of the first firewall is open to network traffic initiated from a specific network address that is outside of the first firewall.

33. The computer program product according to claim 26, wherein computer program code for pushing comprises computer program code for pushing at least a subset of the collected process control system data from the host to the isolation system via a first firewall, where all ports of the first firewall are closed to any network traffic initiated from outside of the first firewall.

34. The computer program product according to claim 27, further comprising:
computer program code for protecting the isolation system with a second firewall placed between the isolation system and the at least one non-network computer.

35. The computer program product according to claim 34, wherein computer program code for protecting comprises computer program code for protecting the isolation system with a second firewall placed between the isolation system and the at least one non-network computer, where at least one selected port of the second firewall is open to network traffic initiated from a specific network address that is outside of the second firewall.

36. The computer program product according to claim 26, further comprising:
computer program code for indicating if the collected process control system data is read-only or if the collected process control system data may be modified.

37. The computer program product according to claim 27, wherein computer program code for collecting involves a first protocol, computer program code for providing involves a second protocol, and computer program code for pushing involves a third protocol.

38. The computer program product according to claim 37, wherein computer program code for collecting involves an object manager data transfer protocol, computer program code for providing involves an X-Windows protocol, and computer program code for pushing involves a application programming interface protocol.
